(19) United States
(12) Patent Application Publication
(10) Pub. No.: US 2006/0278408 A1
(43) Pub. Date: Dec. 14, 2006

(54) Horseshoe set for race horses

(76) Inventor: Robert J. Perazzini, Waterbury, CT (US)

Correspondence Address: Arthur G. Schaier;Carmody & Torrance LLP, P.O. Box 1110, 50 Leavenworth Street, Waterbury, CT, 06721-1110, US

(21) Appl. No.: 11/354,519

(22) Filed: Feb. 15, 2006

Related U.S. Application Data
(60) Provisional application No. 60/652,658, filed on Feb. 15, 2005.

(51) Int. Cl. A01L 1/04

(52) U.S. Cl. 168/4

(57) ABSTRACT

A set of horseshoes for race horses made of Zytel®211 nylon with an embedded metal toe grab, and having front horseshoes with a relieved toe portion on the bottom side contacting the ground, and having rear horseshoes with a gradually thickening toe portion on the top side contacting the hoof.

### RELATED APPLICATIONS

This application claims the benefit of U.S. Provisional Application No. 60/652,458, filed Feb. 15, 2005.

This invention relates generally to improved non-metallic horseshoes, and more particularly to an improved set of front and rear horseshoes for racehorses.

### BACKGROUND OF THE INVENTION

Currently the horseshoe of choice for racehorses is made of aluminum in the conventional arcuate configuration corresponding to the shape of the horse's hoof and attached in the conventional manner with nails through spaced nail holes as is well known in the art. The aluminum horseshoes must be shaped to the proper size and configuration to fit the hoof. While aluminum horseshoes are light in weight, an aluminum horseshoe lasts only one month on racehorses before it has to be tightened. Also, aluminum transfers heat quickly and can aggravate the hoof causing a brittle hoof and cracked heel.

For the above reasons, non-metallic, moldable plastic materials have been proposed for horseshoes. A number of prior art constructions and methods of attachment have been proposed, using synthetic resin materials. Metallic inserts have also been proposed, which are imbedded in the resin material and project to form “toe grabs”. Calks, defined as downwardly extending projections, also may be provided as embedded metal inserts, or molded as an integral part of the non-metallic horseshoe.

A number of U.S. patents have disclosed horseshoes of synthetic resin material of more or less conventional shape, some of these having metallic toe grab inserts, the following list being exemplary.

U.S. Pat. No. 3,050,133 issued Aug. 21, 1962 to Ketner discloses plastic horseshoes intended for racehorses having a metallic arcuate insert for a toe grab with tapered toe portions on the horseshoes for the forefeet, and a tapered calk on the bottom side of the horseshoes for the hind feet. Thermoplastic epoxy resins are the preferred materials.

U.S. Pat. No. 3,283,825 issued Nov. 8, 1966 to Ward describes a metallic toe insert for a non-metallic horseshoe, and U.S. Pat. No. 3,310,115 issued Mar. 21, 1967, also to Ward, describes a non-metallic horseshoe and method of attachment to a horse's hoof. The Ward patents mention a number of possible materials including hard rubber, synthetic rubber, nylon, Teflon, and Mylar.

U.S. Pat. No. 3,494, 422 issued Feb. 10, 1970 to Clark, describes a plastic horseshoe, stating that nylon is unsatisfactory and expressing preference for elastomeric polyurethane.

U.S. Pat. No. 4,972,909 issued Nov. 7, 1990 to Rose describes a horseshoe of glass fiber filled thermoplastic polyurethane and contains a summary of other prior art non-metallic horseshoes.

U.S. Pat. No. 4,993,494 issued Feb. 19, 1991 to Tuunanen discloses a non-metallic shoe with an internal ductile insert of a special plastic material.

U.S. Pat. No. 5,048,614 issued Sep. 17, 1991 to Klimko, discloses another horseshoe of conventional shape, molded of cyanaprene urethane and containing metal inserts.

In order for horseshoes to be most effective on racehorses, they should be flexible to allow the heel to spread, the material must be resistant to shock and impact, and a good insulator to heat. The configuration of the shoe must be designed differently for the forefeet and the hind feet, to account for the fact that when a horse is racing, the heel portions of the forefeet strike the ground first, whereas the toe portions of the hind feet strike the ground first.

Accordingly, one object of the present invention is to provide improvements in non-metallic horseshoes as to the material used and the configurations for the front shoes and rear shoes.

Another object of the invention is to provide an improved set of front and rear non-metallic horseshoes especially designed for improving the performance of racehorses.

Still another object of the invention is to provide improved non-metallic front and rear horseshoes for racehorses which reduce the likelihood of injury to the feet of the horses.

### SUMMARY OF THE INVENTION

Briefly stated, the invention comprises an improved set of front and rear horseshoes of the type having an upper side for attachment to a horse's hoof and a lower side, each molded of non-metallic material in an arcuate configuration corresponding to the shape of a hoof and having a central toe portion, a pair of attachment portions each defining an recess in a lower side thereof with spaced nailing holes and terminating in a pair of heel portions, the central portion having an arcuate metal toe grab embedded therein and protruding from the lower side thereof. The improvement of the present invention comprises using Nylon 6 for the non-metallic material, relieving the heel portions of the front horseshoes on the lower side thereof to provide a gradually thinning cross-section toward the terminating ends of the heel portions, and thickening the heel portions of the rear horseshoes toward the upper side thereof to provide a gradually thickening cross-section toward the terminating ends of the heel portions. Preferably the Nylon 6 material comprises Zytel® 211 manufactured by E. I. DuPont deNemours & Company, or equivalent formulation.

### DRAWING

The invention will be better understood by reference to the following description, taken in connection with the accompanying drawing, in which:

FIG. 1 is a side elevational view of a racehorse's forefoot wearing the improved front horseshoe,

FIG. 2 is an elevational view of a portion of the same racehorse's hind foot wearing the improved rear horseshoe,

FIG. 3 is a plan view of the front horseshoe viewed from the lower or ground contacting side thereof,

FIG. 4 is a side elevational view, partly in cross-section, taken along line IV-IV,

FIG. 5 is a side elevational view in cross-section, taken along lines V-V,

FIG. 6 is a plan view of the rear horseshoe, viewed from the lower or ground contacting side thereof,

FIG. 7 is a side elevational view, partly in cross-section, taken along lines VII-VII, and

FIG. 8 is a side elevational view in cross-section taken along lines VIII-VIII of FIG. 6.

### DESCRIPTION OF THE PREFERRED EMBODIMENT

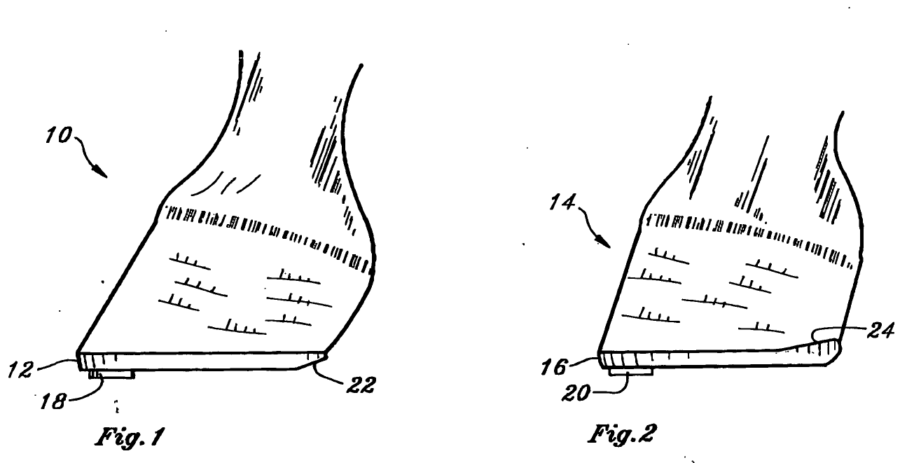

Referring now to FIGS. 1 and 2 of the drawing, portions of a forefoot and a hind foot respectively of a racehorse are illustrated. FIG. 10 shows a forefoot 10 shod with an improved front horseshoe 12 made according to the present invention, while FIG. 2 illustrates a racehorse's hind foot 14 shod with an improved rear horseshoe 16 made according to the present invention. As indicated by the characteristic profile of the horseshoes, front shoe 12 includes a projecting metal toe grab 18, and shoe 16 includes a similar metal toe grab 20.

In accordance with the present invention, the heel portions of the front horseshoes 2 are relieved, as indicated at 22 on the lower side to provide a gradually thinning cross-section. The heel portions of the rear horseshoe 16 are thickened on the upper side thereof, as indicated at 24, to provide a gradually thickening cross-section toward the end. Rear horseshoe 16 is slightly shorter than front horseshoe 12 to accommodate the slightly more erect hind foot 14.

In accordance with the present invention, the material for the non-metallic horseshoes 12, 16 (other than the metal toe grabs 18, 20) is from the family of polyamides known as Nylon 6 or polycaprolactam. The preferred Nylon 6 formulation is Zytel® 211 manufactured by E. I. DuPont deNemours & Company, or an equivalent formulation.

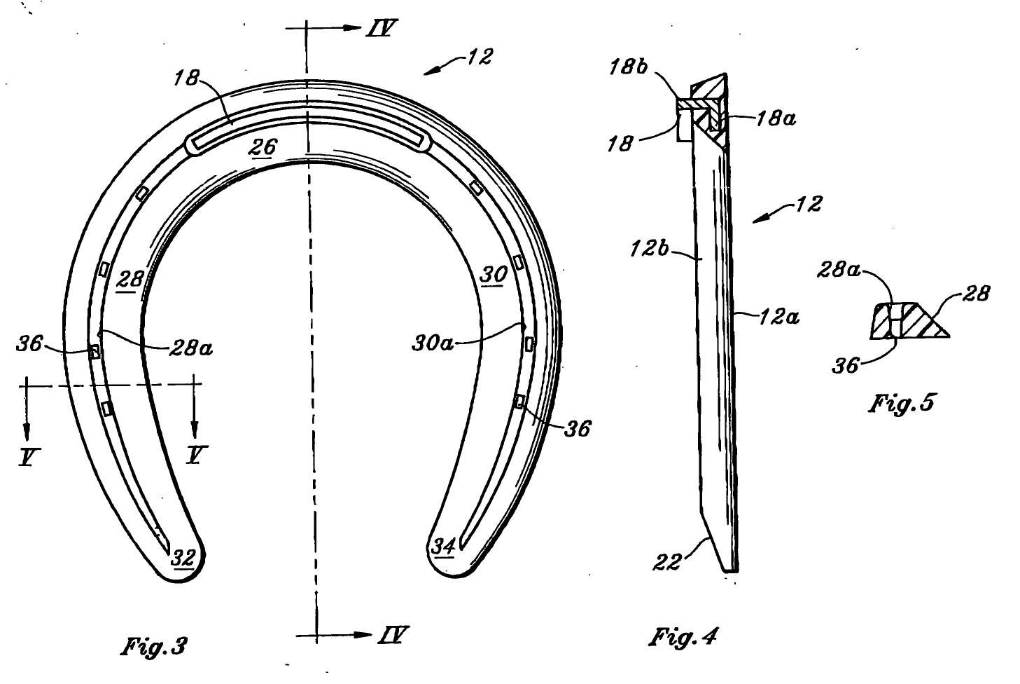

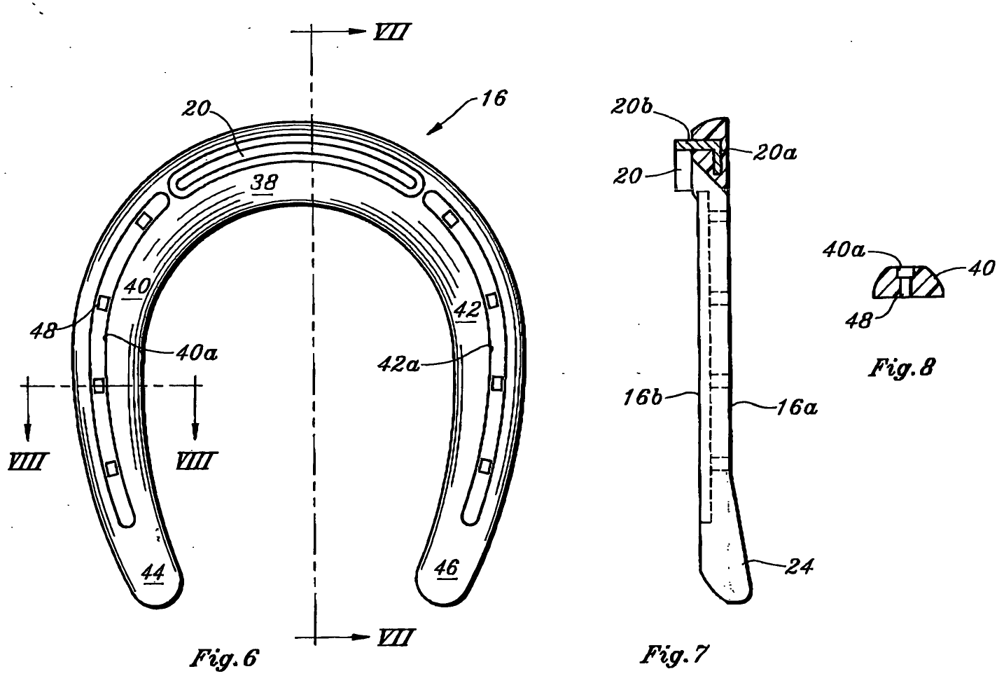

The construction of the improved horseshoes is made clear by reference to FIGS. 3 through 5 for the front horseshoe and FIGS. 6 through 8 for the rear horseshoe.

The front horseshoe 12, shown in plan view in FIG. 3, has a conventional arcuate configuration corresponding to the shape of a hoof, with a central toe portion 26, a pair of attachment portions 28, 30, and a pair of heel portions 32, 34. Front horseshoe 12 has an upper side 12a which attaches to the horse's hoof and a lower side 12b which contacts the ground. The upper side 12a is substantially flat throughout. The toe portion 26 includes an embedded metal toe grab 18, which is formed in an arcuate shape conforming to the contour of the toe portion 26. As seen in FIG. 4, toe grab 18 includes a flange 18a imbedded in the Nylon 6 material and a projecting portion 18b.

The attachment portions 28, 30, define arcuate recesses 28a, 30a, respectively, in lower side 12b, and are provided with spaced nail holes 36 in the recesses. FIG. 5 illustrates a cross-section taken through the attachment portion 28.

In accordance with the invention, the heel portions 32, 34 are relieved on the lower side as shown at 22 to provide a gradually thinning cross-section toward the terminating ends of the heel portions. The relief angle is on the order of 20° from the horizontal.

Referring to FIGS. 6 through 8 of the drawings, the rear horseshoe 16 includes a metallic toe grab 20 formed in an arcuate shape like the previously described toe grab. The rear horseshoe 16 includes a central portion 38, a pair of attachment portions 40, 42, and a pair of heel portions 44, 46. Horseshoe 16 has an upper side 16a and a lower side 16b. The upper side 16a is substantially flat over the central portion 38 and attachment portions 40, 42.

Reference to FIG. 7 cross-section shows toe grab 20 has a flange 20a imbedded in the resin with a projecting portion 20b. Attachment portions 40, 42, include arcuate recesses 40a, 42a, with spaced nail holes 48 in lower side 16b. FIG. 8 illustrates a cross-section through the attachment portion 40.

In accordance with the present invention, the heel portions 44, 46 are thickened toward the upper side 16a, to provide a gradually thickening cross-section toward the terminating ends of the heel portions, as illustrated at 24. The angle of increasing thickness is on the order of 10° from the horizontal

The prior art mentions a number of non-metallic materials for horseshoes, such as hard rubber, synthetic rubber, nylon, Teflon, Mylar, polyurethane, cyanaprene urethane, and many others. While nylon is mentioned as a material, I have found that most nylons are, in fact, unacceptable materials for horseshoes for racehorses, because of the extreme conditions and other forces imposed on the shoes during a race. However, I have found that one class of nylon products, specifically Nylon 6, provides excellent results, due to its flexibility, resistance to impact and ease of casting or injection molding into the configuration of the horseshoes described above and illustrated in FIGS. 1-8. Particularly Zytel® 211, a formulation of Nylon 6 manufactured by E. I. DuPont deNemours and Company, has been found to provide superior results for the shoes illustrated.

The preferred horseshoe, cast or injection molded from Nylon 6, preferably Zytel® 211, provides a flexible shoe which can be flexed to conform to the hoof and then attached with nails in the conventional manner. The Nylon 6 allows the imbedding of metallic inserts of various shapes and other imbedded metal calks if desired. The high impact resistance of Nylon 6 reduces possible cracking or breaking of the shoe during a race. As is known, when a horse is runing, the heel portion of the front hoof strikes the ground before the toe portion, whereas the toe portion of the rear hoof strikes the ground before the heel portion. To accommodate this, the heel portion of the front shoe 12 is relieved as shown at 22 to reduce the effect of impact when the heel of the forefoot first strikes the ground. As to the hind foot of the horse, contrary to the conventional projections from the lower side of the heel portions of the shoe, the heel portions are thickened toward the upper side as illustrated at 24. This results in greater and more uniform support of the hind foot heel as it strikes the ground. Mud calks can also be added to project from the lower side of shoe 16 if desired.

While there has been described what is considered to be the preferred embodiment of the invention, other modifications will occur to those skilled in the art, and it is desired to secure in the appended claims all such modifications as fall within the true spirit and scope of the invention.

What I claim as new is:

1. An improved set of front and rear horseshoes for racehorses, each of said horseshoes being of the type having an upper side for attachment to a horse's hoof and a lower side, each said horseshoes being molded of non-metallic material in an arcuate configuration corresponding to the shape of a said hoof and having a central toe portion, a pair of attachment portions each defining an arcuate recess in the lower side thereof and further defining spaced nailing holes therethrough, and terminating in a pair of heel portions, said central portion having an arcuate metal toe grab embedded therein and protruding from the lower side thereof, said improvement comprising:
said non-metallic material comprising Nylon 6,
the heel portions of the front horseshoes being relieved on the lower side thereof to provide a gradually thinning cross-section toward the terminating ends of the heel portions, and
the heel portions of the rear horseshoes being thickened toward the upper side thereof to provide a gradually thickening cross-section toward the terminating ends of the heel portions.

2. The improvement according to claim 1, wherein said Nylon 6 comprises Zytel® 211.

3. The improvement according to claim 1, wherein the upper side of the central toe portion and the upper side of the attachment portions of the rear horseshoes are substantially flat.

4. The improvement according to claim 1, wherein the upper side of the front horseshoes is substantially flat.

5. The improvement according to claim 1, wherein the heel portions of the front horseshoes are relieved at an angle on the order of 20° from the horizontal.

6. The improvement according to claim 1, wherein the heel portions of the rear horseshoes are thickened along an angle on the order of 10° from the horizontal.

7. An improved set of front and rear horseshoes for racehorses, each of said horseshoes being of the type having an upper side for attachment to a horse's hoof and a lower side, each said horseshoes being molded of non-metallic material in an arcuate configuration corresponding to the shape of a said hoof and having a central toe portion, a pair of attachment portions each defining an arcuate recess in the lower side thereof and further defining spaced nailing holes therethrough, and terminating in a pair of heel portions, said central portion having an arcuate metal toe grab embedded therein and protruding from the lower side thereof, said improvement comprising:
said non-metallic material comprising Zytel® 211,
the heel portions of the front horseshoes being relieved on the lower side thereof at an angle on the order of 20° from the horizontal to provide a gradually thinning cross-section toward the terminating ends of the heel portions, and the heel portions of the rear horseshoes being thickened toward the upper side thereof along an angle on the order of 10° from tho horizontal to provide a gradually thickening cross-section toward the terminating ends of the heel portions.
